(19) United States
(12) Patent Application Publication
(10) Pub. No.: US 2012/0320632 A1
(43) Pub. Date: Dec. 20, 2012

(54) POWER SWITCH CONTROLLERS AND METHODS USED THEREIN FOR IMPROVING CONVERSION EFFECIENCY OF POWER CONVERTERS

(75) Inventors: Siarhei Kalodka, Taipei (TW); Chien-Liang Lin, Keelung City (TW); Sergey Gaitukevich, Taipei City (TW)

(73) Assignee: SHAMROCK MICRO DEVICES CORP., Taipei (TW)

(21) Appl. No.: 13/163,729

(22) Filed: Jun. 20, 2011

(51) Int. Cl. H02M 3/335

(52) U.S. Cl. 363/16

(57) ABSTRACT

Power switch controllers and methods used therein are disclosed. An exemplifying power switch controller includes a window provider, a sensor and a logic controller. The window provider provides minimum and maximum time signals to indicate the elapses of a minimum time and a maximum time, respectively. The sensor detects a terminal of an inductive device, to generate a trigger signal. The logic controller prevents a power switch connected to the inductive device from being turned on before the elapse of the minimum time, forces the power switch to be turned on after the elapse of the maximum time, and turns on the power switch if the trigger signal is asserted.

### BACKGROUND

The present disclosure relates generally to power supplies and the control methods used therein.

Power converters or adapters are devices that convert electric energy provided from batteries or power grid lines into power source with a specific voltage or current, such that electronic apparatuses are powered accordingly. For modern apparatuses that are required to be friendly to the world we live, conversion efficiency, which is the ratio of the power provided to a load powered by a power converter over the power delivered to the power converter over, is always a big concern. The less the power consumed by a power converter itself, the higher the conversion efficiency of the power converter.

Power converters operating in quasi-resonant (QR) mode are proved, in both theory and practice, to work more efficiently than most of other power converters, due to that power switches operated in QR mode are switched at zero current or voltage, resulting in an essentially lossless switch.

FIG. 1 illustrates a flyback converter 8, which is capable of operating in QR mode. Circuit 10 illustrates flyback topology, including power switch 15, primary winding PRM and secondary winding SEC of a transformer, a diode, and a current sense resistor. When power switch 15 is ON, performing a short circuit, primary winding PRM energizes. When power switch 15 is OFF, performing an open circuit, secondary winding SEC de-energizes to power node OUT through a diode. Power switch controller 18 controls ON time T_{ON} or OFF time T_{OFF} of power switch 15, based on feedback signal V_{FB} provided at node FB by feedback circuit 20, which monitors node OUT. The higher the feedback signal V_{FB}, the higher the output power required to maintain the voltage at node OUT. Operating voltage source generator 12 provides voltage source V_{cc} at node VCC to power switch controller 18. Resistor 14 connects one terminal of auxiliary winding AUX to node ZCD of power switch controller 18, to provide the energy status of the transformer.

FIGS. 2A and 2B show waveforms of voltage signal V_{ZCD} at node ZCD under different load conditions. FIG. 2A corresponds to a relatively heavier load, and FIG. 2B to a relatively lighter load. It can be seen from FIGS. 2A and 2B that voltage signal V_{ZCD} starts to oscillate after the transformer de-energizes completely and results in voltage valleys VLY₁, VLY₂, VLY₃, and so forth. The lighter the load, the earlier the completion of de-energizing, the earlier the occurrences of voltage valleys. A power supply in QR mode can operate to start energizing at the moment when any one of the voltage valleys occurs. FIG. 3 illustrates the relationships between switch frequency f_{CYC} and feedback signal V_{FB} at node FB, where switch frequency f_{CYC} is the inverse of cycle time T_{CYC}, which is the summation of ON time T_{ON} and OFF time T_{OFF}, ON time T_{ON} referring to the time period when a power switch is ON, and OFF time T_{OFF} to the time period when it is OFF. For example, Curve 22₁ shows the V_{FB}-to-f_{CYC} relationship if power switch 15 is switched at the moment when voltage valley VLY₁ occurs. Curve 22₂ shows the V_{FB}-to-f_{CYC} relationship if power switch 15 is switched at the moment when voltage valley VLY₂ occurs. And so forth. As shown in FIG. 3, if a power supply is designed to switch its power switch at a specific voltage valley, switch frequency f_{CYC} increases adversely as feedback V_{FB} decreases. The higher switch frequency f_{CYC}, the higher power to charge and discharge a control node of a power switch, resulting in less conversion efficiency.

### SUMMARY

Embodiments of the present invention disclose a power switch controller suitable to control a power switch connected to an inductive device. The power switch controller includes a window provider, a sensor and a logic controller. The window provider provides minimum and maximum time signals to indicate the elapses of a minimum time and a maximum time, respectively. The sensor detects a terminal of the inductive device, to generate a trigger signal. The logic controller prevents the power switch from being turned on before the elapse of the minimum time, forces the power switch to be turned on after the elapse of the maximum time, and turns on the power switch if the trigger signal is asserted.

Embodiments of the present invention disclose a method for controlling a power switch connected to an inductive device. A terminal of the inductive device is detected to generate a trigger signal. The power switch is turned on if the trigger signal is asserted. Before the elapse of a minimum time, the power switch is prevented from being turned on. After the elapse of a maximum time, the power switch is enforced to be turned on.

### BRIEF DESCRIPTION OF THE DRAWINGS

The invention can be more fully understood by the subsequent detailed description and examples with references made to the accompanying drawings, wherein:

FIG. 1 illustrates a flyback converter;

FIGS. 2A and 2B show waveforms of voltage signal V_{ZCD} at node ZCD under different load conditions;

FIG. 3 illustrates the relationships between switch frequency f_{CYC} and feedback signal V_{FB} at node FB;

FIG. 4 exemplifies a power switch controller adaptable to the flayback converter of FIG. 1;

FIG. 5 exemplifies a window provider;

FIG. 6 illustrates the waveforms of signals in FIGS. 4 and 5;

FIG. 7 illustrates two diagrams, the upper one showing the changes of minimum time T_{MIN} and maximum time T_{MAX} vs. feedback signal V_{FB}, and the lower one showing the changes of maximum frequency f_{MAX} and minimum frequency f_{MIN} vs. feedback signal V_{FB};

FIG. 8 includes curve 50 illustrating the relationship between switch frequency f_{CYC} and feedback signal V_{FB} for power switch controller 30 in FIG. 4;

FIGS. 9A and 9B show two window providers; and

FIG. 10 illustrates the relationship between switch frequency f_{CYC} and feedback signal V_{FB} for power switch controller 30 in FIG. 4 if window provider 40 is embodied by window provider 60a or 60b.

### DETAILED DESCRIPTION

Objects of the present invention and more practical merits obtained by the present invention will become more apparent from the description of the embodiments which will be given below with reference to the accompanying drawings. For explanation purposes, components with equivalent or similar functionalities are represented by the same symbols. Hence components of different embodiments with the same symbol are not necessarily identical. Here, it is to be noted that the present invention is not limited thereto.

The following embodiments are exemplified by flyback converters, but are not intended to limit the scope of the invention. A person skilled in the art could apply the concept of the invention to converters with different topologies, such as bulk converters, buck-boost converters, boost converters, and so forth.

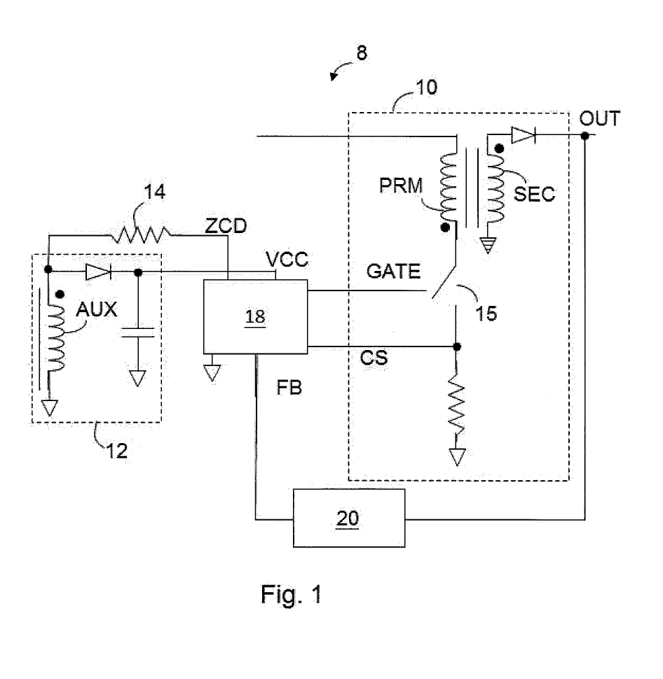

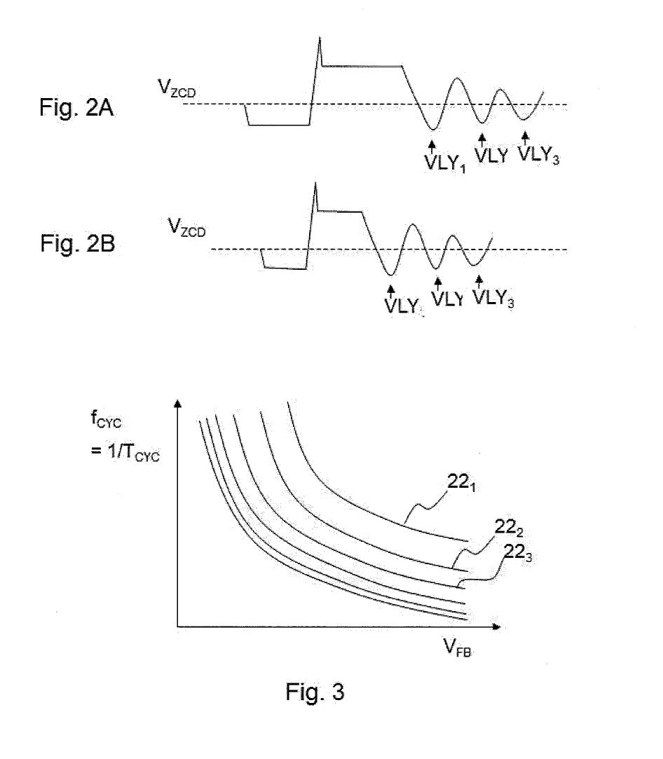

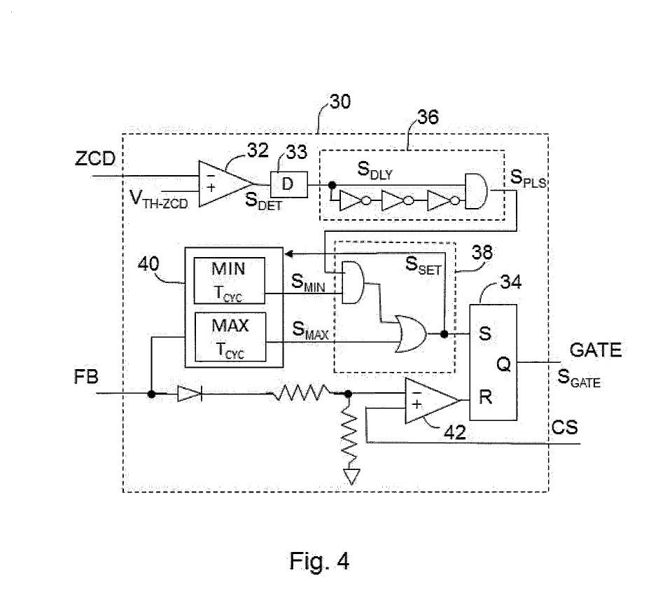

FIG. 4 exemplifies power switch controller 30 adaptable to flyback converter 8 of FIG. 1. Comparator 32, delay circuit 33 and pulse generator 36, as a whole acting as a sensor, detects one terminal of auxiliary winding AUX to generate trigger signal S_{PLS} with pulses, each expectedly corresponding to an occurrence of a voltage valley at node ZCD. Window provider 40 provides minimum and maximum time signals, S_{MIN} and S_{MAX}, to indicate the elapses of a minimum time T_{MIN} and a maximum time T_{MAX}. Logic controller 38 includes several logic gates, controls the S terminal of SR register 34, and determines when power switch 15 is switched to be ON. Only when minimum time signal S_{MIN} is asserted to indicate that minimum time T_{MIN} has elapsed, trigger signal S_{PLS} is possible to pass through logic controller 38 and, if asserted, set SR register 34. In other words, logic controller 38 prevents power switch 15 from being turned on before the elapse of minimum time T_{MIN}. If trigger signal S_{PLS} is not asserted and maximum time T_{MAX} elapses, maximum time signal S_{MAX} sets SR register 34 anyway, power switch 15 is forced to be turned ON, and the flyback converter enters into a following switch cycle. When signal V_{CS} at current sense node CS exceeds the voltage at the inverse input of comparator 42, SR register 34 is reset and power switch 15 is switched to be OFF. Accordingly, feedback signal V_{FB} at node FB substantially decides the peak voltage of signal V_{CS} or the power supplied to node OUT in a switch cycle.

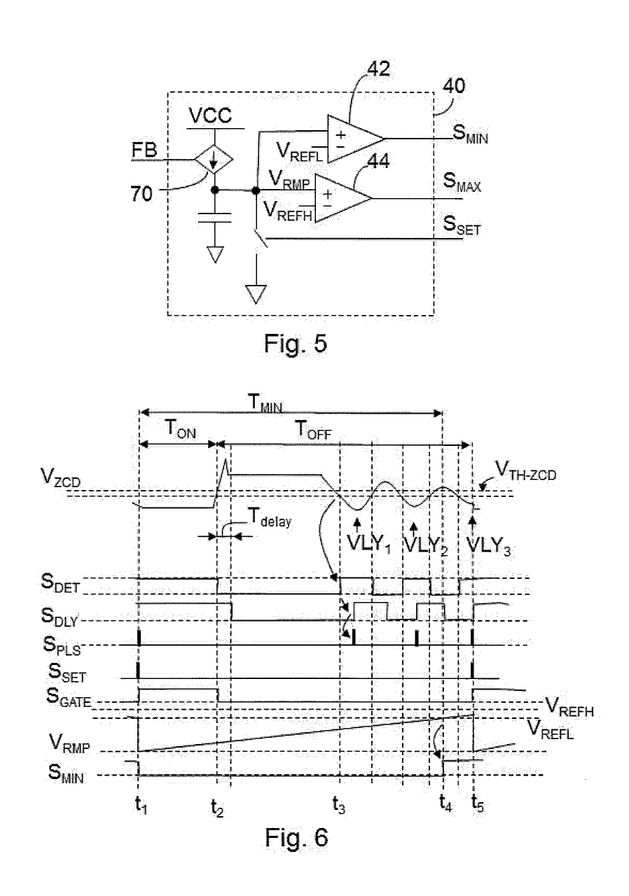

FIG. 5 exemplifies window provider 40, which receives set signal S_{SET}, and outputs minimum and maximum time signals, S_{MIN} and S_{MAX}. When set signal is asserted, ramp signal V_{RMP} is grounded. When set signal is de-asserted, ramp signal V_{RMP} starts to increase, with a slope determined by the output current of voltage-controllable current source 70, which is controlled by feedback signal V_{FB} at node FB. Feedback signal V_{FB} substantially represents the power required by a load at node OUT. At the moments when ramp signal V_{RMP} exceeds reference voltages V_{REFL} and V_{REFH}, minimum and maximum time signals S_{MIN} and S_{MAX} are toggled or asserted, respectively, indicating the elapses of minimum time T_{MIN} and maximum time T_{MAX}, respectively. Reference voltage V_{REFL} should be less than reference voltage V_{REFH}, such that minimum time signal S_{MIN} is asserted earlier. If the output current of voltage-controllable current source 70 decreases, the slope of ramp signal V_{RMP} is less and it takes more time for ramp signal V_{RMP} to reach reference voltages V_{REFL} and V_{REFH}, such that both minimum time T_{MIN} and maximum time T_{MAX} increase. It can be derived by those skilled in the art that minimum time T_{MIN} and maximum time T_{MAX} provided in FIG. 5 are in proportion.

FIG. 6 illustrates the waveforms of signals in FIGS. 4 and 5. Waveforms in FIG. 6 are, from top to bottom, voltage signal V_{ZCD} at node ZCD, signal S_{DET} from comparator 32, signal S_{DLY} from delay circuit 33, trigger signal S_{PLS} from pulse generator 36, set signal S_{SET} at S terminal of SR register 34, gate signal S_{GATE} at node GATE, ramp signal V_{RMP} in FIG. 5, and minimum time signal S_{MIN} from comparator 42. The pulse of set signal S_{SET} at time t₁ turns on power switch 15 and grounds ramp signal V_{RMP}. ON time T_{ON} is determined by feedback signal V_{FB}, such that gate signal S_{GATE} changes at time t₂, causing the rising of voltage signal V_{ZCD}, the logic change of signal S_{DET}, and the logic change of signal S_{DLY}, which is delayed by delay time T_{delay} in comparison with signal S_{DET}. At time t₃, it is the first time that voltage signal V_{ZCD} drops across 0V after the completion of de-energization, causing after delay time T_{delay} the rising edge of signal S_{DLY}, which accordingly results in a pulse in trigger signal S_{PLS} output from pulse generator 36. Before time t₄, as ramp signal V_{RMP} is under reference voltage V_{REFL}, minimum time signal S_{MIN} remains 0 in logic, such that pulses in trigger signal S_{PLS}, if any, are blocked from reaching S terminal of SR register 34 and set signal S_{SET} remains 0 in logic. After time t₄ when minimum time T_{MIN} has elapsed, ramp signal V_{RMP} has exceeded reference voltage V_{REFL} and minimum time signal S_{MIN} changes into logic 1, such that at time t₅ the pulse in trigger signal S_{PLS} is passed to be set signal S_{SET} and turn on power switch 15, starting a following switch cycle. As shown in FIG. 6, if delay time T_{delay} is well designed, each pulse in trigger signal S_{PLS} could represent the occurrence of a voltage valley of voltage signal V_{ZCD} and power switch 15 is turned ON at time t₅ when voltage valley VLY₃ occurs, substantially performing an operation in QR mode.

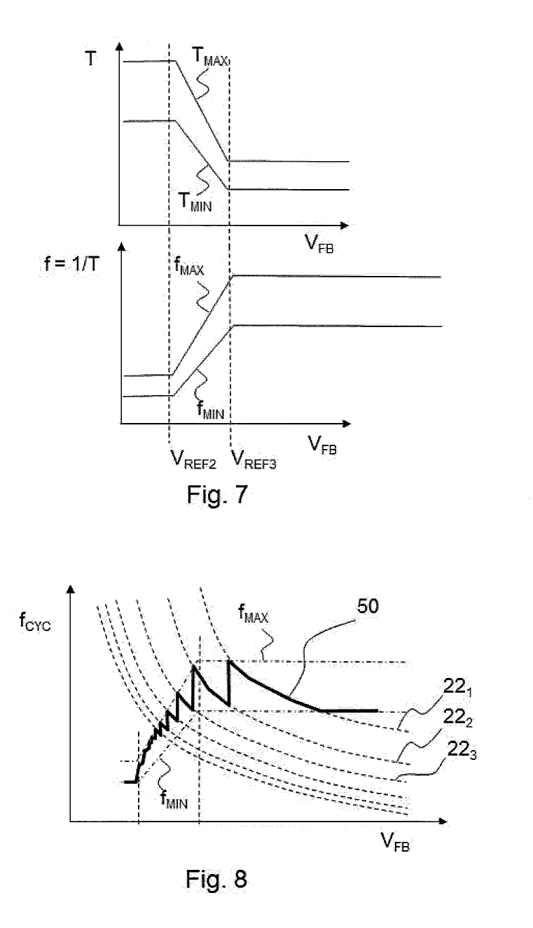

FIG. 7 illustrates two diagrams, the upper one showing the changes of minimum time T_{MIN} and maximum time T_{MAX} vs. feedback signal V_{FB}, and the lower one showing the changes of maximum frequency f_{MAX} and minimum frequency f_{MIN} vs. feedback signal V_{FB}. As minimum time T_{MIN} is the earliest time that power switch controller 30 in FIG. 4 can turn ON a power switch, its inverse, 1/T_{MIN}, defines a maximum switching frequency f_{MAX} that power switch controller 30 can perform. Similarly, 1/T_{MAX}, the inverse of maximum time T_{MAX}, defines a minimum frequency f_{MIN}.

Voltage-controllable current source 70 in FIG. 5 could be well designed to achieve the curves in FIG. 7. For example, the output current from voltage-controllable current source 70 is a respectively-lower constant if feedback signal V_{FB} is under reference voltage V_{REF2}, increases linearly if feedback signal V_{FB} approaches from reference voltage V_{REF2} to reference voltage V_{REF3}, and is a respectively-higher constant if feedback signal V_{FB} is over reference voltage V_{REF3}. It is shown in FIG. 7 that minimum time T_{MIN} decreases as feedback signal V_{FB} increases if feedback signal V_{FB} is between reference voltages V_{REF2} and V_{REF3}.

FIG. 8 includes curve 50 illustrating the relationship between switch frequency f_{CYC} and feedback signal V_{FB} for power switch controller 30 in FIG. 4. The dashed curves in FIG. 8 duplicate maximum frequency f_{MAX} and minimum frequency f_{MIN} of FIG. 7, and the curves in FIG. 3 showing the relationships between switch frequency f_{CYC} and feedback signal V_{FB}. It can be derived based on the aforementioned teaching that power switch controller 30 turns on power switch 15 substantially at the occurrence of the earlier voltage valley after minimum time T_{MIN}, but no later than maximum T_{MAX}. Accordingly, curve 50 is limited to locate somewhere between minimum frequency f_{MIN} and maximum frequency f_{MAX}, and traces the highest one among curves 22₁, 22₂, 22₃ . . . . It can be seen from FIG. 8 that switch frequency f_{CYC} power switch controller 30 provides is somehow lower for light load when feedback signal V_{FB} is less, because the switching of a power switch might shift to the moment when a subsequent voltage valley occurs. Within the time period of a switch cycle, the control node of power switch 15 is charged and discharged once, requiring a certain amount of power. Less switch frequency f_{CYC} results in less power for charging and discharging the control node of power switch 15, increasing power conversion efficiency for light load.

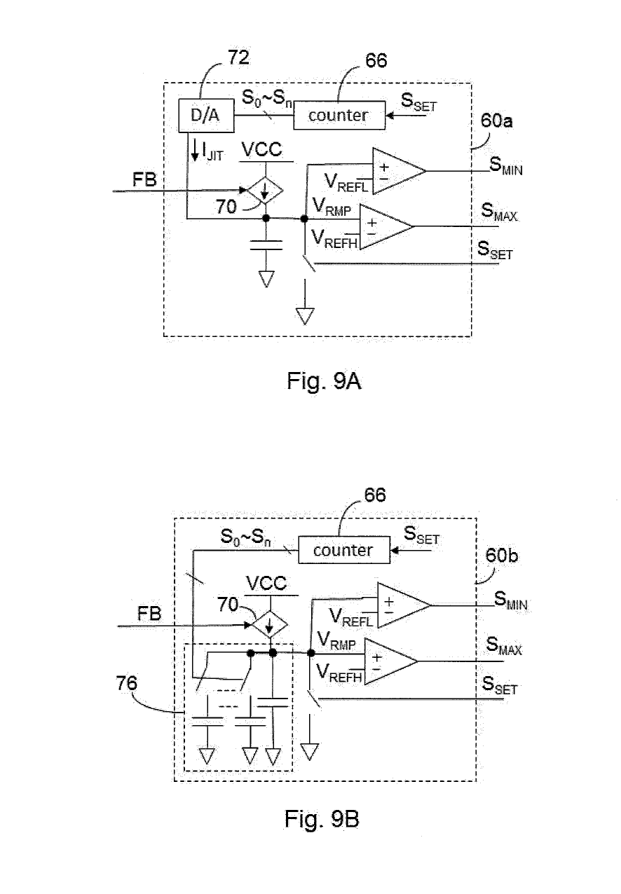

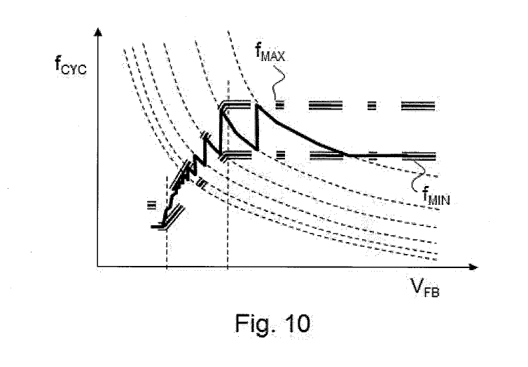

As shown in FIG. 8, for very heavy load when feedback signal V_{FB} is so high, switch frequency f_{CYC} substantially stays at the constant defined by minimum frequency f_{MIN}, raising the concern of electromagnetic interference (EMI). FIGS. 9A and 9B show window providers 60a and 60b that are two alternatives to window provider 40 and could solve this concern, using the technology of jittering. In addition to what is shown in window provider 40 of FIG. 5, each of window providers 60a and 60b has counter 66 cycling its digital outputs S₀˜Sₙ every several milliseconds while switch frequency f_{CYC} has a clock cycle time around the order of microseconds. Of window provider 60a, there is a digital-to-analog converter 72 that receives digital outputs S₀˜Sₙ and generates a corresponding relatively-little current I_{JIT}, such that the total current charging the capacitor jitters over time. Of window provider 60b, the effective capacitance of capacitor array 76 in FIG. 9B jitters because it is slightly changed by digital outputs S₀˜Sₙ. As the current charging the capacitor or the capacitance of the capacitor array jitters, both minimum frequency f_{MIN} and maximum frequency f_{MAX} are no more two constants for a certain feedback signal V_{FB}, but jitter over time. FIG. 10 illustrates the relationship between switch frequency f_{CYC} and feedback signal V_{FB} for power switch controller 30 in FIG. 4 if window provider 40 is embodied by window provider 60a or 60b. In FIG. 10, the curves representing minimum frequency f_{MIM} and maximum frequency f_{MAX} are dashed and triple-lined to indicate that they are not constant but jittering. Shown in FIG. 10, for very heavy load when feedback signal V_{FB} is so high, switch frequency f_{CYC} is no more a constant but jitters as minimum frequency f_{MIN} does.

Benefits of the aforementioned embodiments include the followings. A power switch controller according to the invention could switch a power switch at the moment when the voltage cross the power switch is around a voltage valley, performing almost lossless switching. For heavy load, this valley could be the 1^{st} voltage valley. For light load or even no load, as switch frequency f_{CYC} is limited to be between minimum frequency f_{MIM} and maximum frequency f_{MAX}, this valley could change into the 2^{nd}, 3^{rd} or even a further subsequent voltage valley. For light load or no load, since minimum frequency f_{MIM} and maximum frequency f_{MAX} become lower, switch frequency f_{CYC} become lower too, saving the power to charge or discharge the control node of the power switch. In case of the very heavy load condition, uttering minimum frequency f_{MIM} prevents or reduces the concern of EMI.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power switch controller, suitable to control a power switch connected to an inductive device, comprising:
a window provider, for providing minimum and maximum time signals to indicate the elapses of a minimum time and a maximum time, respectively;
a sensor for detecting a terminal of the inductive device, to generate a trigger signal; and
a logic controller, for preventing the power switch from being turned on before the elapse of the minimum time, forcing the power switch to be turned on after the elapse of the maximum time, and turning on the power switch if the trigger signal is asserted.

2. The power switch controller as claimed in claim 1, wherein a feedback signal is provided to substantially represent the power required by a load, and the minimum time decreases as the feedback signal increases.

3. The power switch controller as claimed in claim 1, wherein the maximum time increases if the minimum time increases.

4. The power switch controller as claimed in claim 1, wherein the maximum time and the minimum time jitter over time.

5. The power switch controller as claimed in claim 1, wherein the maximum and minimum signals are generated based on a ramp signal.

6. The power switch controller as claimed in claim 1, wherein the inductive device is a transformer with a primary winding and an auxiliary winding, and the sensor detects a terminal of the auxiliary winding.

7. A method for controlling a power switch connected to an inductive device, comprising:
detecting a terminal of the inductive device to generate a trigger signal;
turning on the power switch if the trigger signal is asserted;
preventing the power switch from being turned on before the elapse of a minimum time; and
enforcing the power switch to be turned on after the elapse of a maximum time.

8. The method as claimed in claim 7, further comprising:
providing a feedback signal representing the power required by a load; and
decreasing the minimum time if the feedback signal is increased.

9. The method as claimed in claim 7, wherein the maximum time is in proportion to the minimum time.

10. The method as claimed in claim 7, further comprising:
uttering the maximum time over time.

11. The method as claimed in claim 7, further comprising:
providing a ramp signal;
generating a minimum time signal based on the ramp signal, to indicate the elapse of the minimum time.

12. The method as claimed in claim 11, further comprising:
generating a maximum time signal based on the ramp signal, to indicate the elapse of the maximum time.

13. The method as claimed in claim 7, wherein the inductive device is a transformer with a primary winding and an auxiliary winding, and the step of detecting detects one terminal of the auxiliary winding.
